(19) United States
(12) Patent Application Publication
(10) Pub. No.: US 2007/0277890 A1
(43) Pub. Date: Dec. 6, 2007

(54) Rotationally adjustable on/off valve for a compressed gas storage tank

(75) Inventor: Roderick A. Perry, Latrobe, PA (US)

Correspondence Address: MARGER JOHNSON & MCCOLLOM, P.C., 210 SW MORRISON STREET, SUITE 400, PORTLAND, OR, 97204, US

(73) Assignee: Smart Parts, Inc., Latrobe, PA (US)

(21) Appl. No.: 11/447,550

(22) Filed: Jun. 5, 2006

(51) Int. Cl. F16K 11/085

(52) U.S. Cl. 137/625.22

(57) ABSTRACT

A valve for a paintball gun preferably includes a valve body, a tank connection member, and a device connection member. The valve can, for instance, be an on/off valve or a tank pin-valve. The device connection member is preferably attached to the valve body in a rotationally adjustable relationship. Alternatively, the tank connection member (or both) could be arranged in a rotationally-adjustable relationship with respect to the valve body. A locking member can be provided to lock one or more of the connection members in a desired orientation with respect to the valve body. In an on/off valve configuration, a vent can be provided to permit venting of residual compressed gas from an attached device when the valve is switched to an off position.

### RELATED APPLICATIONS

This application is related to co-pending U.S. patent application Ser. No. 11/125,724, filed May 9, 2005, the contents of which are hereby incorporated by reference in their entirety.

### BACKGROUND OF THE INVENTION

This invention relates generally to valves for compressed gas storage devices. More particularly, this invention relates to valves for supplying a compressed gas, such as CO₂ or other compressed gas, from a compressed gas source to a pneumatic device, such as a paintball gun (“marker”), nail gun, or other pneumatic device.

FIGS. 1A and 1B are schematic cross-sectional side views illustrating a conventional CO₂ storage tank and valve assembly 100 having an anti-siphon tube 112 arranged in the tank 105 according to the background art. Anti-siphon tubes are desirable for applications using CO₂ as a gas source because they can help prevent drawing liquid CO₂ into a regulator, solenoid, or other components of a connected pneumatic device.

Referring to FIG. 1A, a conventional anti-siphon tube 112 for a CO₂ bottle 105 typically comprises a metal tube permanently affixed to an inward end of a threaded CO₂ valve 110. The metal tube is angled on the opposite end toward one side of the CO₂ bottle to direct it toward the CO₂ gas 20, and to prevent it from accepting liquid CO₂ 20A when that side of the CO₂ bottle is arranged upwardly. A marking may be placed on the valve 110 to indicate an upward position of the tank and valve assembly 100.

Unfortunately, this conventional setup requires the CO₂ bottle 105 with the attached valve 110 and anti-siphon tube 112 to be arranged in a specific orientation when attached to the paintball gun or other pneumatic device so that the proper side of the CO₂ bottle is always arranged upwardly. Otherwise, as shown in FIG. 1B, if the CO₂ tank and valve assembly 100 is arranged so that the anti-siphon tube 112 is directed downwardly, the tube 112 is likely to draw liquid CO₂ 20A from the tank. In such instances, the anti-siphon tube actually increases the problem it is supposed to solve.

To prevent this, CO₂ tanks fitted with conventional anti-siphon tubes are typically matched to a specific paintball marker or other device to make sure that the anti-siphon tube is arranged pointing upwardly at its end when the tank is fully threaded into the device. In the conventional solution, therefore, the CO₂ bottle equipped with the valve and anti-siphon tube cannot be used with another paintball marker or device having threads in a different orientation without risking drawing liquid CO₂ into that device. Drawing liquid CO₂ into the paintball gun or other device can significantly impair the functioning of the device, reduce the lifespan of the device, and even cause the device to stop working entirely.

FIG. 2A is a somewhat schematic cross-sectional and front plan view of a prior art on/off valve as shown and described in U.S. Pat. No. 6,260,821. Prior art on/off valves, such as that depicted in FIG. 2A, provide a mechanism for selectively supplying compressed gas from a compressed gas source to an attached device. Unfortunately, these conventional on/off valves have not presented a solution to the problem discussed previously of properly orienting anti-siphon tubes.

In addition, conventional on/off valves may lack a mechanism for venting compressed gas from an attached device when the valve is switched to an off position. The failure to vent the compressed gas may result in a residual quantity of compressed gas remaining in the attached device that may be used to operate the device unintentionally, even after the valve is switched off. When the attached device is a paintball gun, paintball players will typically need to fire one or more clearing shots after a conventional valve is shut off, or manually actuate a separate bleed valve, to ensure that all the compressed gas has been expelled from the marker.

The industry is therefore in need of a valve for a CO₂ tank or other compressed gas storage device that is adaptable for use with a variety of paintball guns or other pneumatic devices. The industry would be particularly benefited by a tank valve that permits rotational adjustment of an orientation of an anti-siphon tube with respect to a connected paintball gun or other device. The industry would be further benefited by an on/off valve that vents residual compressed gas from the attached device when switched to an off position.

### SUMMARY OF THE INVENTION

According to various principles of the present invention, an improved valve for a pneumatic system preferably enables adjustment of the orientation of the valve and an associated compressed gas storage tank with respect to a device connection member of the valve. The valve may, for instance, be an on/off valve, a pin valve, or other type of valve.

For example, according to one possible embodiment of the present invention, an on/off valve for a paintball gun can include a valve body that receives a rotationally adjustable device connection member. A locking member can be provided to lock the position of the device connection member with respect to the valve body. The valve body can also include a source connection member for connection to a compressed gas source. The source connection member can be attached to an anti-siphon tube through an anti-siphon tube connector. An actuator can be configured to selectively control a flow of the gas through the valve.

According to still further aspects of the present invention, an on/off valve may include a vent for releasing pressure from a device connection member when the valve is switched to an off position. A burst disc may also be provided to safely vent a connected compressed gas tank if it becomes over-pressurized.

Although the principles of the present invention are explained with reference to certain specific embodiments, additional embodiments and configurations of the invention will also become readily apparent to those of ordinary skill in the art based on the disclosure herein contained. The invention should therefore not be construed as being limited to the features or arrangements of any one or more of the particular embodiments described herein.

### BRIEF DESCRIPTION OF THE DRAWINGS

The foregoing and other objects, features, and advantages of the invention will become more readily apparent from the following detailed description which proceeds with reference to the accompanying drawings, in which:

FIG. 1A is a schematic cross-sectional side view of a conventional CO₂ tank with an anti-siphon tube installed therein, shown with the anti-siphon tube arranged in the proper orientation;

FIG. 1B is a schematic cross-sectional side view of a CO₂ tank with an anti-siphon tube installed therein, shown with the anti-siphon tube arranged in an improper orientation;

FIG. 2A is a somewhat schematic cross-sectional and front elevation view of an on/off valve for a compressed gas tank according to the prior art;

FIG. 2B is a somewhat schematic cross-sectional side view of a compressed gas tank and on/off valve having a compressed gas cylinder safety device installed therein according to a separate invention;

FIG. 3 is a somewhat schematic right side elevation view of a rotationally adjustable on/off valve incorporating various principles of the present invention, shown with an anti-siphon tube attached thereto;

FIG. 4 is a somewhat schematic cross-sectional view of the on/off valve of FIG. 3, taken along line A-A;

FIG. 5 is a somewhat schematic cross-sectional view of the on/off valve, similar to that of FIG. 4, shown with a device connection member separated from a valve body;

FIG. 6 is a somewhat schematic left side elevation view of the on/off valve of FIG. 3;

FIG. 7 is a somewhat schematic cross-sectional left side view of the on/off valve of FIG. 3, illustrating a further aspect of the present invention; and

FIG. 8 is a somewhat schematic perspective view of the on/off valve of FIG. 3.

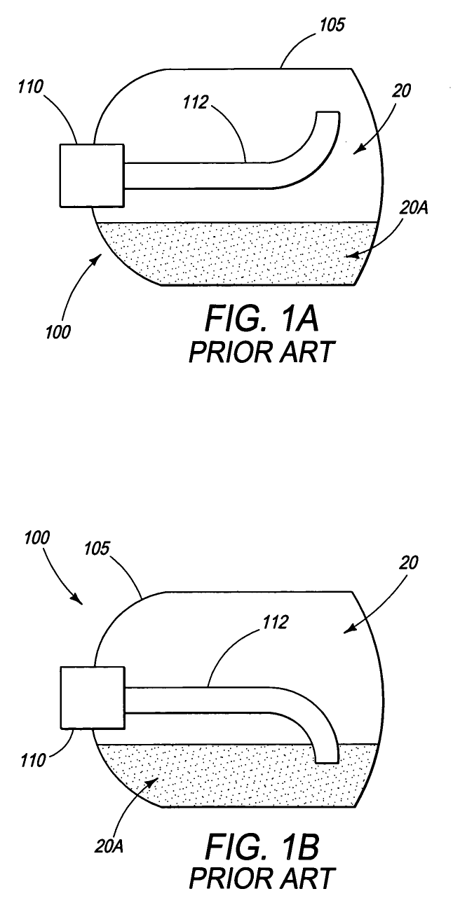

### DETAILED DESCRIPTION

The principles of the present invention will now be described more fully hereinafter with reference to particular embodiments thereof. It should be recognized, however, that the invention may be embodied in many different forms and need not include every feature of the described embodiments. The invention should therefore not be construed as being limited to any one or more of the embodiments set forth herein, nor as requiring the specific features or a specific combination of features of these embodiments, except as may be expressly recited in the claims.

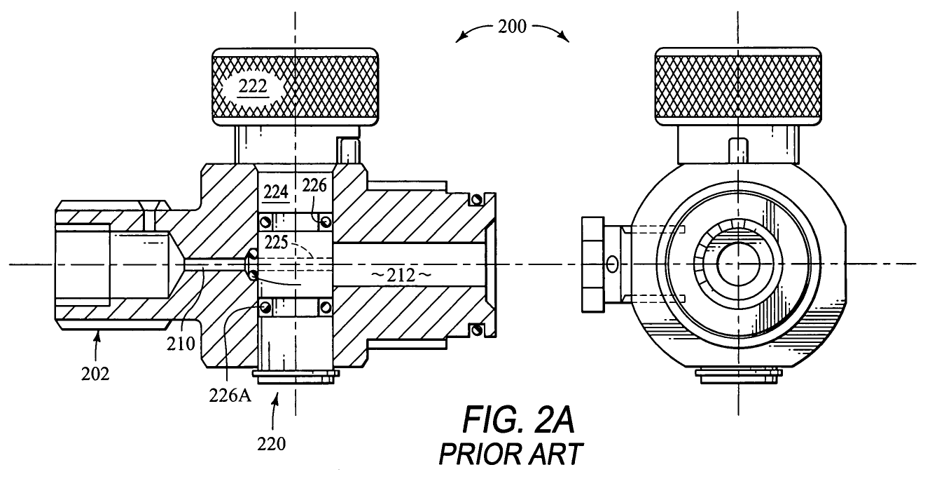

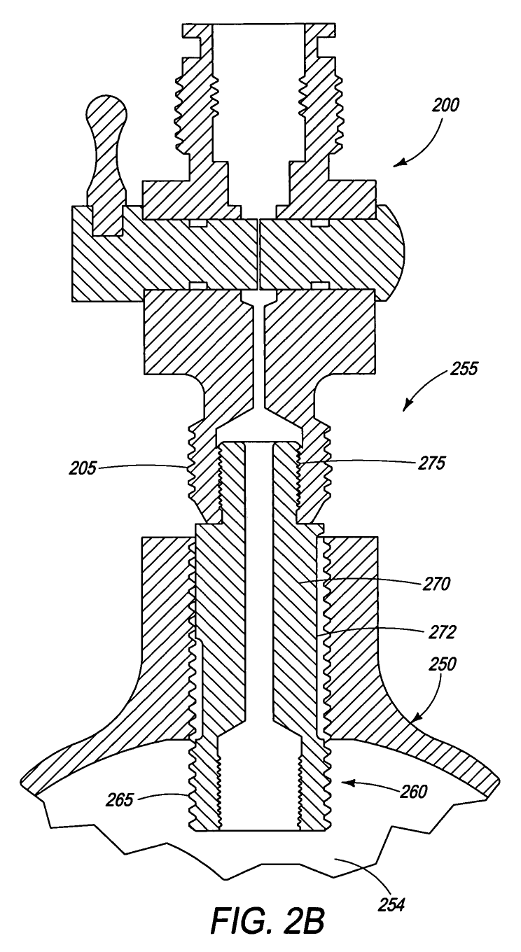

FIG. 2A shows the construction of the prior art on/off valve disclosed in U.S. Pat. No. 6,260,821. The internal construction of the on/off mechanism of the present invention can be constructed similar to that of the prior art on/off valve shown in FIG. 2A. A brief description of that on/off valve 200 will therefore be provided herein.

Referring to FIG. 2A, an on/off valve 200 can include a valve body 202 with apertures including a gas inlet 210 and a gas outlet 212. The valve body 202 can further include a cavity 215, extending laterally through the body 202 between the inlet 210 and the outlet 212. A valve actuating member 220 is positioned within the cavity 215. An actuator (such as a knob, lever, or other actuator) 222 is provided on an external portion of the valve actuating member 220 attached to a valve stem 224. The valve stem 224 extends into and through the cavity 215. A flow aperture 225 is provided through the valve stem 224. The actuator 222 can be rotated to turn the valve 200 on or off.

O-rings 226, 226A extend around the valve stem 224 within grooves 227, 227A on opposite lateral sides of the inlet 210 and outlet 212. The o-rings 226, 226A prevent the gas from leaking out through the cavity ends and ensure that the gas from the gas inlet 210 travels to the gas outlet 212 when the valve 200 is open. They can also provide redundancy and dust protection. When the actuator 222 is located in an “on” position, the flow aperture 225 is arranged in communication with both the inlet 210 and the outlet 212 in order to permit a flow of the gas from the inlet 210 to the outlet 212.

A body o-ring 230 is provided within the valve body 202. Specifically, the body o-ring 230 can be located inside either an exit port of the gas inlet 210 or in an entry port of the gas outlet 212. The body o-ring 230 provides a seal between the valve body 202 and the valve stem 224, and prevents gas from leaking out of the inlet 210. Because the o-ring surrounds the inlet 210 of the valve body, it helps prevent gas leakage regardless of the position of the actuator 222. It can therefore perform a sealing function when the actuator is the “on” position (open valve) as well as when it is in the “off” position (closed valve). This configuration also prevents the body o-ring 230 from moving relative to the valve body 202 and thereby substantially eliminates the risk of the body o-ring 230 being cut or damaged by burs in the body 202. This is desirable because it is easier to machine the valve stem 224 to remove burs than to remove burs from the surface of the cavity 215.

In operation, the valve 200 is switched between an open (“on”) position and a closed (“off”) position through rotation (e.g., 90°) of the valve stem 224 via the actuator 222. In an open position, the flow aperture 225 is arranged in communication with the inlet 210 and permits a flow of gas from the inlet 210 to the outlet 212. In a closed position, communication between the flow aperture 225 and the inlet 210 is severed. The body o-ring 230 provides a seal between the valve body 202 and the valve stem 224. In the open position, the seal ensures the gas will travel through the flow aperture 225. In a closed position, the seal retains the gas within the inlet 210. O-rings 226, 226A provide additional sealing, redundancy, and dust protection by preventing dust or other foreign substances from entering the valve assembly around the plug and by preventing leaks when the inlet o-ring 230 becomes worn or damaged. They also prevent leakage from the outlet 220 through the cavity ends.

A preferred embodiment of the present invention provides advantages over the prior art on/off valve described above by enabling rotational adjustment of the valve body with respect to a device connection member. Not only does this facilitate proper orientation of an anti-siphon tube connected to the valve body in CO₂ applications, but further allows positioning of the on/off actuating mechanism in an orientation that is convenient to the user in both CO₂ and other applications.

FIG. 2B illustrates a compressed gas cylinder safety device 255 according to a separate invention. Referring to FIG. 2B, a safety device 255 includes a valve stem 260 and an on/off valve assembly 200. The safety device 255 is shown in a partially removed position with respect to a compressed gas cylinder 250. The valve stem 260 can include a first threaded section 265, an elongated, non-threaded section 270, and a second threaded section 275. The first threaded section 265 is preferably configured to engage the threads 252 inside the neck of the compressed gas bottle 250.

The elongated, non-threaded section 270 is preferably configured to vent any compressed gas remaining in the bottle before the first threaded section is removed from the bottle. This can be accomplished, for example, using vent channels 272 arranged along an outer surface of the safety device or vent holes arranged through the safety device. In this way, compressed gas stored in the compressed gas tank 250 can be released in a safe manner if the valve 200 is detached from the tank 250, without the risk of the tank 250 acting as a projectile. The various embodiments of the present invention may also incorporate a device similar to the safety device 255. The safety device is explained in further detail in U.S. patent application Ser. No. 11/125,724, the contents of which are hereby incorporated by reference in their entirety.

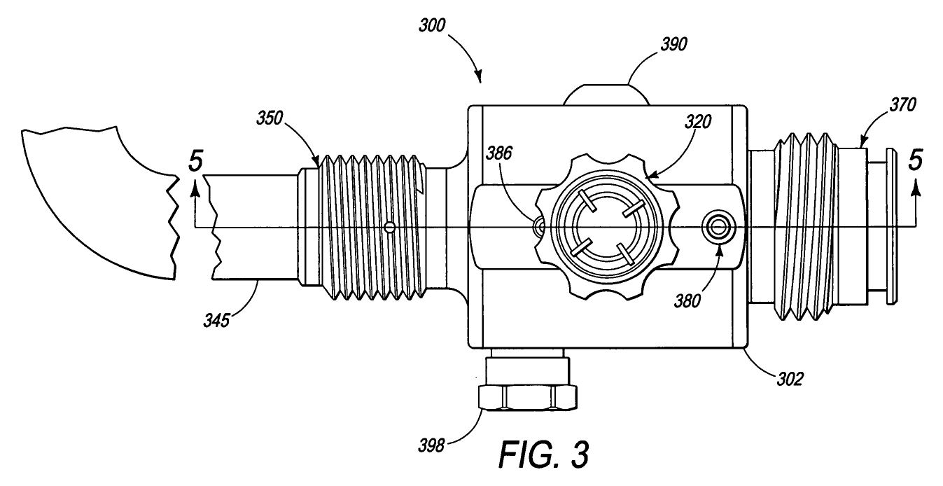

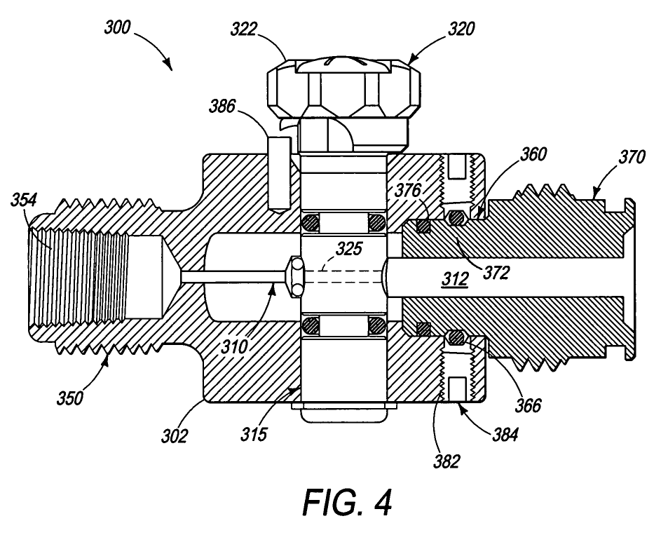

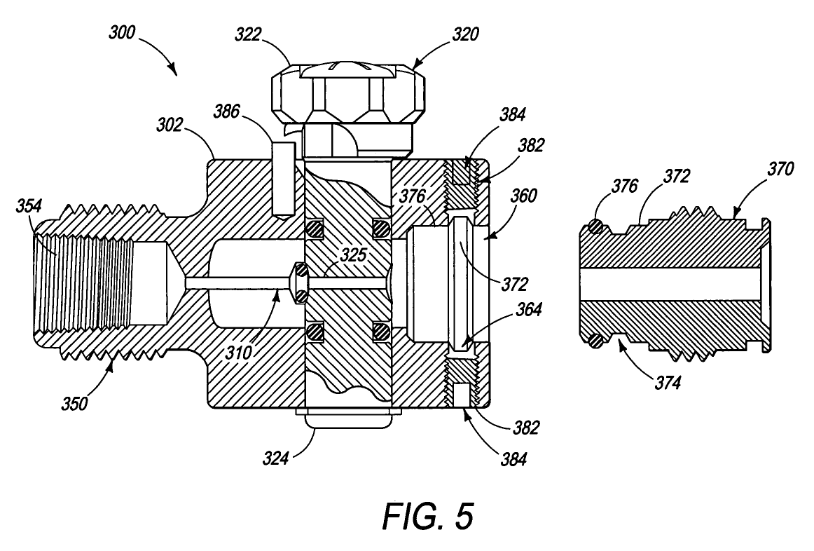

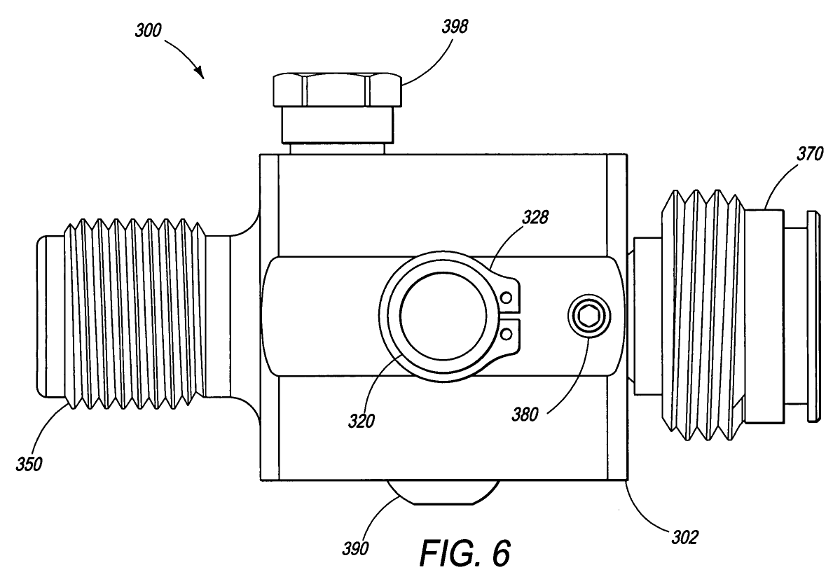

FIGS. 3-8 illustrate various principles of the present invention through a preferred embodiment thereof. Referring to FIGS. 3-8, an on/off valve 300 can include a valve body 302 having a tank connection member 350 that facilitates attachment between the on/off valve 300 and a compressed gas storage device (not shown), such as a compressed gas storage tank or bottle, through a threaded or other removable or permanent connection. The compressed gas can, for instance, be CO₂, nitrogen, compressed air, or other desirable compressed gas. In CO₂ applications, an anti-siphon tube 345 can be attached to the tank connection member 350, for example through a threaded connection or through another removable or permanent connection.

In this embodiment, external threads of a connection end the anti-siphon tube 345 preferably mate with internal threads 354 of the tank connection member 350. The anti-siphon tube 345 is preferably arranged in a desired orientation with respect to the valve body 302 such that a desired upward position of the valve body 302 corresponds to an upward orientation of the end of the anti-siphon tube 345 within the CO₂ tank. The anti-siphon tube 345 can then be rigidly affixed to the on/off valve 300 such as through loctite, welding, or other mechanical, chemical or other rigid connection mechanism. The tank is then preferably connected to the tank connection member 350 of the valve 300, such as through a threaded or other connection. The tank can be rigidly affixed to the valve 300 to prevent accidental removal of the tank from the valve 300.

The valve body 302 can further include a receptacle 360. The receptacle 360 is preferably configured to receive a stem 372 of a device connection member 370. The device connection member 370 can preferably be rotated within the receptacle 360 of the valve body 302. Ball bearing grooves 374 can be provided in the device connection member 370 with corresponding ball bearing grooves 364 arranged in the receptacle 360. Ball bearings 366 are preferably arranged in the ball bearing grooves 364, 374 to facilitate smooth rotation of the device connection member 370 within the receptacle 360. An o-ring 376 can be provided around the stem 372 to seal the area between the stem 372 and the receptacle 360.

A locking mechanism 380 can be provided to secure the device connection member 370 in a desired orientation with respect to the valve body 302. The locking mechanism 380 can, for instance, be one or more threaded plugs 382 arranged within plug holes 384 in the valve body 302. In this embodiment, the threaded plugs 382 can be configured to apply a locking force on the device connection member 370 when tightened and to relieve the locking pressure when loosened. The plug holes 384 can also be configured and arranged to permit ball bearings 366 to be inserted into the ball bearing grooves 364, 374 when the device connection member 370 is arranged in the receptacle 360. The threaded plugs 382 can be tightened, for instance, to apply a locking force onto the device connection member 370 by applying pressure on the ball bearings 366 arranged in the ball bearing grooves 364, 374.

A cavity 315 can be arranged through the valve body 302 to receive the actuating member 320. A flow aperture 325 is preferably arranged through the actuating member 320. When the actuating member 320 is rotated to an on (or open) position using the actuator 322, the flow aperture 325 provides a fluid path for the flow of compressed gas from the tank connection member 350 to the device connection member 370 through the fluid passageways 310, 312. A stop 386 can be provided to prevent rotation of the actuator 322 beyond a desired range of motion. A clip 328 can be provided to retain the actuating member in the cavity 315.

To adjust the on/off valve 300 for use with a particular pneumatic device, the device connection member 370 of the valve 300 can be fully threaded into the pneumatic device and the locking member 380 can be disengaged to permit rotation of the valve body 302 with respect to the device connection member 370. The valve body 302 is then preferably rotated to arrange it in a desired orientation with respect to the attached device. In CO₂ applications where an anti-siphon tube 345 is provided, the valve body 302 is preferably oriented so that the attached anti-siphon tube 345 is arranged having its end facing upwards in the CO₂ tank when the device is in its operating position. Once oriented, the locking mechanism 380 is preferably engaged to prevent accidental rotation of the valve body 302 with respect to the device connection member 370. In this manner, the valve 300 can be adjusted to permit proper operation with any one of multiple pneumatic devices. This process can be repeated if the operator wishes to use the compressed gas storage device and attached on/off valve 300 with another pneumatic device.

Various tamper-resistant devices can be implemented to help prevent accidental unlocking of the locking mechanism 380. The locking mechanism 380 can, for instance, be adapted to permit unlocking only with special tools or only by appropriate persons, such as qualified airsmiths. This may be desirable to prevent inexperienced users from tampering with the orientation of the valve assembly.

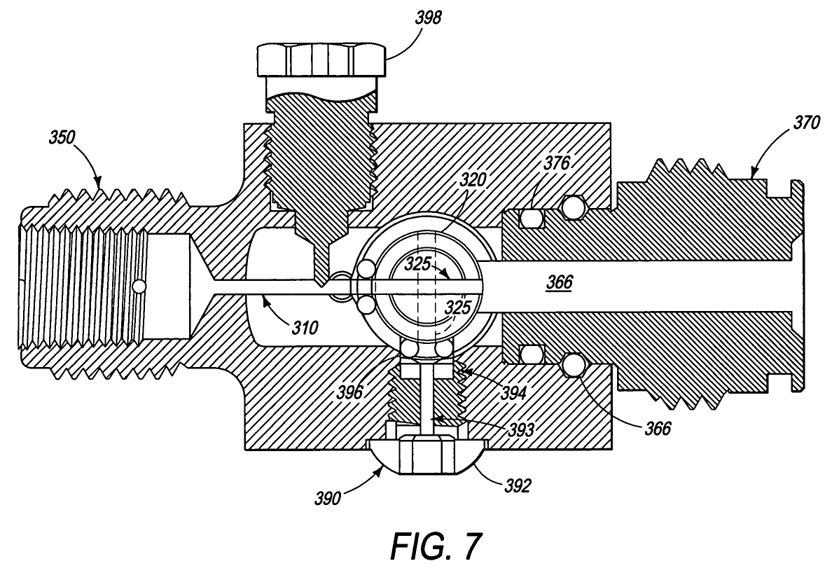

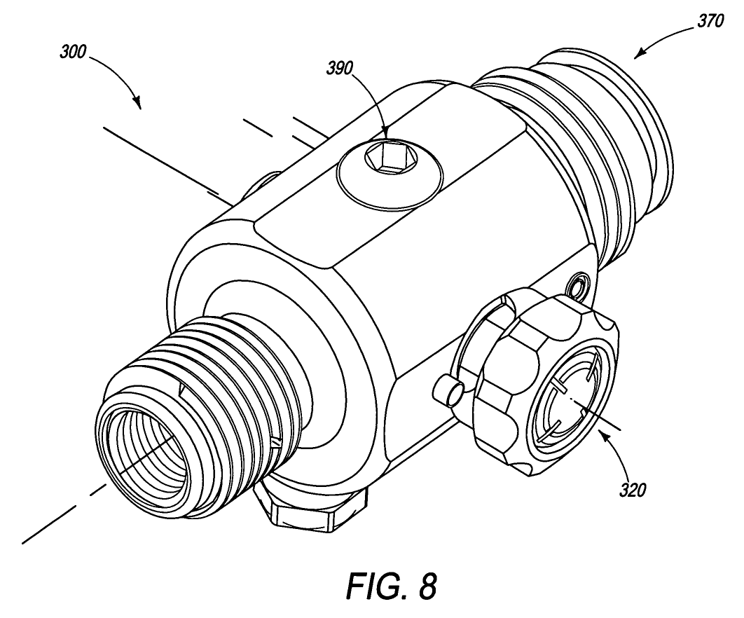

According to another aspect of the present invention, a vent 390 can be provided to release compressed gas accumulated in an attached device when the on/off valve 300 is switched to an off position. Referring specifically to FIG. 7, a vent port 394 can be arranged through a sidewall of the valve body 302. An o-ring 396 can be arranged in a base of the vent port 394 in communication with the valve actuation member 320 to seal off the vent port 394 when the valve 300 is in its on position. A vent plug 392 can be arranged in the vent port 394 to hold the o-ring in place and control the venting of compressed gas through a flow aperture 393.

In operation, when the valve actuator 320 is switched to the off position (represented by the dashed lines), the flow aperture 325 is aligned with the vent port 394. Compressed gas accumulated in an attached device can thereby be released via the flow passageway 312 of the device connection member 370, the flow aperture 325 of the actuating member 320, and the flow aperture 393 in the vent plug 392. In this manner, residual compressed gas can be released from the attached device when the valve is switched to the off position. This can help prevent accidental operation of the attached pneumatic device and eliminates the need to manually vent residual compressed gas in other ways, such as by firing clearing shots when the attached device is a paintball gun. A burst disc 398 can also be provided on the on/off valve to permit safe release of compressed gas stored in the tank if it becomes over-pressurized.

Having described and illustrated the principles of the invention in a preferred embodiment and various alternative embodiments thereof, it should be apparent that the invention can be modified in arrangement and detail without departing from such principles. Among other things, it should be readily apparent that while certain principles of the present invention have been described with respect to an on/off valve, they are equally applicable to other types of valves, such as pin valves or other valves. Other variations can also be made within the scope of the present invention. The invention should therefore be construed to cover all modifications and variations coming within the spirit and scope of the following claims.

What is claimed is:

1. A valve for a compressed gas tank, comprising:
a valve body;
a tank connection member connected to the valve body;
a device connection member connected to the valve body;
wherein an orientation between the valve body and one or more of the device connection member and the tank connection member is rotationally adjustable; and
a valve configured to control a flow of compressed gas between a tank connected to the tank connection member and a device connected to the device connection member.

2. A valve according to claim 1, further comprising:
a device connection member receptacle located within the valve body; and
a stem arranged on the device connection member, said stem configured to mate with the device connection member receptacle of the valve body to permit rotational adjustment of the valve body with respect to the device connection member.

3. A valve according to claim 2, wherein the stem comprises a groove for receiving a seal to prevent leakage of compressed gas.

4. A valve according to claim 2, wherein the stem and valve body each comprise a ball-bearing groove configured to receive and retain a plurality of ball bearings in a space between the stem and a wall of the receptacle.

5. A valve according to claim 2, further comprising a locking mechanism configured to lock the position of the device connection member with respect to the valve body.

6. A valve according to claim 5, wherein the locking mechanism comprises a threaded plug arranged in a plug hole of the valve body, and wherein the threaded plug is configured to apply a locking force on the stem of the device connection member when arranged in a locking position.

7. A valve according to claim 6, further comprising a plurality of threaded plugs arranged in a plurality of plug holes disposed in the valve body.

8. A valve according to claim 1, further comprising an anti-siphon tube coupled to the tank connection member of the valve body.

9. A valve according to claim 1, wherein the valve comprises an on/off valve, said on/off valve further comprising a vent for releasing compressed gas from a device connection member when a valve actuator is arranged in an off position.

10. A valve for a compressed gas storage tank, comprising:
a valve body having a first connection member and a receptacle; and
a second connection member having a stem arranged in the receptacle, wherein said second connection member is capable of rotational movement with respect to the valve body.

11. A valve according to claim 10, further comprising:
an anti-siphon tube coupled to the first connection member of the valve body, said anti-siphon tube being arranged in a desired position with respect to the valve body.

12. A valve according to claim 11, further comprising a locking member adapted to lock a position of the valve body with respect to the second connection member such that the anti-siphon tube is arranged in a desired orientation when the second connection member is connected to an external device.

13. A valve according to claim 12, wherein the locking member comprises a threaded plug disposed in a plug hole of the valve body, wherein the threaded plug is adapted to apply a locking force on the stem of the second connection member when the locking member is in a locking position.

14. A valve according to claim 10, wherein the valve comprises an on/off valve having a valve actuator configured to permit a flow of gas from the valve to an attached device when the valve actuator is in an actuated position, and wherein the valve further comprises a vent port adapted to vent compressed gas from the attached device when the valve actuator is arranged in a deactuated position.

15. An on/off valve for a compressed gas tank, comprising:
a valve body comprising a first connection end adapted to be connected to a compressed gas tank, a cavity adapted to receive a valve actuator, and a receptacle adapted to receive a second connection member;
a valve actuating member arranged within the cavity, said valve actuating member having a flow aperture that permits fluid communication between the first connection end and the receptacle when the valve actuating member is in a first position; and
wherein the second connection member is arranged in the receptacle in a manner that permits rotational adjustment of the orientation of the valve body with respect to the second connection member.

16. An on/off valve according to claim 15, further comprising an anti-siphon tube coupled to the first connection end.

17. An on/off valve according to claim 15, further comprising a vent to vent compressed gas from the receptacle when the valve actuating member is arranged in a second position.

18. An on/off valve according to claim 15, further comprising a locking mechanism that can lock the position of the valve body with respect to the second connection member.

19. An on/off valve according to claim 18, wherein the locking mechanism comprises a threaded plug.

20. An on/off valve according to claim 15, wherein the second connection member comprises a stem arranged to mate with the receptacle, and wherein the stem and receptacle each comprise a corresponding ball-bearing groove.
